(19) United States
(12) Patent Application Publication
(10) Pub. No.: US 2026/0194446 A1
(43) Pub. Date: Jul. 9, 2026

(54) OUT-FIELD DETECTION DEVICE AND METHOD FOR DETECTING PASSIVATION FEATURE OF STAINLESS STEEL

(71) Applicant: CHINA UNIVERSITY OF PETROLEUM (EAST CHINA), Qingdao (CN)

(72) Inventors: Jiantao QI, Qingdao (CN); Yongqiang ZHU, Qingdao (CN); Yonghao LIU, Qingdao (CN); Hanbing WANG, Qingdao (CN); Yang AN, Qingdao (CN); Yulong YANG, Qingdao (CN); Xinyi ZHANG, Qingdao (CN)

(73) Assignee: CHINA UNIVERSITY OF PETROLEUM (EAST CHINA), Qingdao (CN)

(21) Appl. No.: 19/207,342

(22) Filed: May 13, 2025

(30) Foreign Application Priority Data
Jan. 8, 2025 (CN) 202510031752.2

(51) Int. Cl. G01N 17/02; G01N 17/00; G01N 21/65; G01N 27/28

(52) U.S. Cl. CPC G01N 17/02; G01N 17/002; G01N 21/65; G01N 27/283; G01N 2201/0227; G01N 2201/023; G01N 2201/1244

(57) ABSTRACT

Disclosed is an out-field detection device, comprising an out-field stainless steel substrate, a passivation solution container, a cover glass, an electrochemical workstation, a Raman spectrometer, a Raman laser emission source, and a peristaltic pump. The passivation solution container is configured to contain a passivation solution; the cover glass is configured to seal the passivation solution container; the peristaltic pump is in fluid communication with the passivation solution container and configured to control flow of the passivation solution; the electrochemical workstation is configured to apply a dynamic potential to the out-field stainless steel substrate and measure a polarization curve, the electrochemical workstation is provided with a working electrode interface configured to establish electrical connection; the Raman laser emission source is configured to emit laser light toward the passivation solution; the Raman spectrometer is configured to obtain a Raman spectrum of the passivation solution.

### CROSS-REFERENCE TO RELATED APPLICATIONS

This application claims priority to Chinese Patent Application No. 202510031752.2, titled “Out-field detection device for passivation behavior of stainless steel based on in-situ electrochemical Raman spectroscopy tracing analysis and method for quantitative characterization of corrosion rate”, filed on Jan. 8, 2025, the entire content of which is incorporated herein by reference.

### TECHNICAL FIELD

The present disclosure relates to the technical field of metal analysis and detection, and in particular to an out-field detection device and a method for detecting a passivation feature of stainless steel.

### BACKGROUND

Stainless steel exhibits good strength, toughness, ductility, and superior corrosion resistance, making it widely applicable in marine, petrochemical, aerospace, and other fields, including out-field equipment such as offshore pipeline systems and aero-engine components, etc. The key to outstanding corrosion resistance in the out-field equipment lies in the ability of stainless steel to form an ultra-thin passive film on the surface. Since the passivation behavior of stainless steel directly impacts the performance of the out-field equipment, real-time monitoring and detection of the passivation behavior is essential.

Therefore, it is desirable a provide an out-field detection device and a method for detecting a passivation feature of stainless steel, so as to improve efficiency and accuracy in monitoring the passivation behavior of stainless steel.

### SUMMARY

One or more embodiments of the present disclosure provide an out-field detection device. The out-field detection device may comprise an out-field stainless steel substrate, a passivation solution container, a cover glass, an electrochemical workstation, a Raman spectrometer, a Raman laser emission source, and a peristaltic pump. The passivation solution container may be configured to contain a passivation solution, the passivation solution being in contact with the out-field stainless steel substrate. The cover glass may be configured to seal the passivation solution container. The peristaltic pump may be in fluid communication with the passivation solution container through a peristaltic pump passivation solution inlet pipe and a peristaltic pump passivation solution outlet, and may be configured to control flow of the passivation solution. The electrochemical workstation may be configured to apply a dynamic potential to the out-field stainless steel substrate and measure a polarization curve. The electrochemical workstation may be provided with a working electrode interface. The working electrode interface may be configured to establish electrical connection between the electrochemical workstation and the out-field stainless steel substrate. The Raman laser emission source may be configured to emit laser light toward the passivation solution. The Raman spectrometer may be configured to obtain a Raman spectrum of the passivation solution by monitoring the passivation solution.

One or more embodiments of the present disclosure provide a method for detecting a passivation feature of stainless steel. The method may comprise: using an out-field stainless steel substrate as a working electrode and connecting the out-field stainless steel substrate with a working electrode interface of an electrochemical workstation; penetrating a metal electrode through a passivation solution container to make one end of the metal electrode be connected with a counter electrode of the electrochemical workstation, and the other end of the metal electrode be inserted into the passivation solution container; injecting a passivation solution into the passivation solution container to make the other end of the metal electrode contact with the passivation solution, and covering the passivation solution container with a cover glass; activating the electrochemical workstation to monitor an open circuit potential of a contact interface between the out-field stainless steel substrate and the passivation solution until the open circuit potential reaches a stable state; measuring a polarization curve of the contact interface using the electrochemical workstation; activating a Raman spectrometer and a Raman laser emission source to obtain a Raman spectrum of the passivation solution; determining, based on the Raman spectrum, a Raman feature peak intensity; determining, based on a correlation model, the Raman feature peak intensity, and the polarization curve, a passivation feature of the out-field stainless steel substrate, the correlation model representing a correspondence between a plurality of Raman feature peak intensities and a plurality of standard solution concentrations, and each of the standard solution concentrations not exceeding 0.1 M.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an exemplary out-field detection device according to some embodiments of the present disclosure;

FIG. 2 is a schematic diagram illustrating a cross-sectional view of an exemplary out-field detection device according to some embodiments of the present disclosure;

FIG. 3 is a flowchart illustrating an exemplary method for detecting a passivation feature of stainless steel according to some embodiments of the present disclosure;

FIG. 4 is a schematic diagram illustrating an exemplary polarization curve according to some embodiments of the present disclosure;

FIG. 5 is a schematic diagram illustrating an exemplary Raman spectrum according to some embodiments of the present disclosure;

FIG. 6 is a schematic diagram illustrating an exemplary process of determining a passivation solution concentration based on a correlation model according to some embodiments of the present disclosure;

FIG. 7 is a flowchart illustrating an exemplary process of monitoring components of a passivation solution according to some embodiments of the present disclosure;

FIG. 8 is a schematic diagram illustrating an exemplary prediction model according to some embodiments of the present disclosure; and

FIG. 9 is a schematic diagram illustrating an exemplary parameter model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one,” “a,” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

In complex out-field environments, the state of a passivation membrane of stainless steel is affected by a plurality of factors. Existing methods for studying the passivation behavior of stainless steel have certain limitations. On the one hand, conventional electrochemical testing means, such as polarization curve measurement, electrochemical impedance spectroscopy, etc., can provide partial information about electrode reaction kinetics and the impedance of the passivation membrane on the surface. However, such means are insufficient to directly obtain structural and compositional information of the passivation membrane at the molecular level. On the other hand, offline analysis means, such as X-ray photoelectron spectroscopy, Auger electron spectroscopy, etc., require the sample to be removed from the reaction environment, which results in the destruction of the original state of the sample and causes the test results to fail to accurately reflect the actual state of the sample.

In-situ electrochemical Raman spectroscopy provides a potential solution to the above issues. This technique enables real-time detection of molecular rotations and vibrations of substances on the electrode surface during operation of the electrochemical system to analyze changes in the molecular structure based on shifts and intensity variations in Raman peaks, thereby revealing microscopic behaviors during the passivation process, including the formation, growth, dissolution, and reconstruction of the passivation membrane. However, existing in-situ electrochemical Raman devices are mostly limited to relatively enclosed and idealized laboratory environments and have not been applied in actual industrial out-field environments.

In practical out-field scenarios, there exist numerous complex and harsh conditions. Traditional laboratory-based in-situ electrochemical Raman devices are difficult to be deployed directly in out-field environments as the precision components of instruments are susceptible to damage, and various interference signals in the out-field environments can easily overwhelm the weak Raman signals. Accordingly, there is an urgent need to develop an out-field detection device and a method for detecting a passivation feature of stainless steel that can adapt to complex out-field conditions, so as to promote the transformation of fundamental research into practical out-field applications.

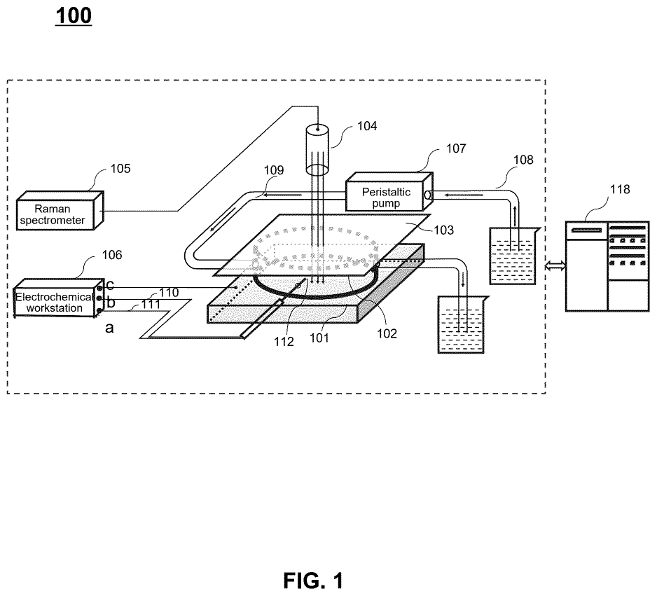

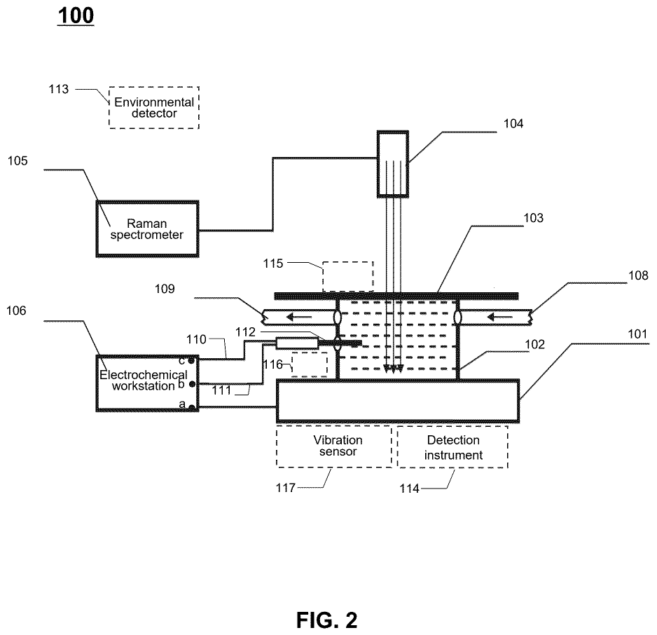

FIG. 1 is a schematic diagram illustrating an exemplary out-field detection device according to some embodiments of the present disclosure. FIG. 2 is a schematic diagram illustrating a cross-sectional view of an exemplary out-field detection device according to some embodiments of the present disclosure.

As shown in FIGS. 1-2, an out-field detection device 100 may include an out-field stainless steel substrate 101, a passivation solution container 102, a cover glass 103, a Raman laser emission source 104, a Raman spectrometer 105, an electrochemical workstation 106, a peristaltic pump 107, a peristaltic pump passivation solution inlet pipe 108, a peristaltic pump passivation solution outlet pipe 109, a counter electrode 110, a reference electrode 111, and a metal electrode 112.

The out-field stainless steel substrate refers to a stainless steel component to be detected in an out-field environment. The out-field environment refers to a practical application scenario outside the laboratory. For example, the out-field environment may include application scenarios such as marine engineering, petrochemical industry, aerospace, etc. In some embodiments, the out-field stainless steel substrate may be a structural component of a device such as a seawater pipeline, an aero-engine component, a ship, etc.

In some embodiments, the out-field stainless steel substrate may be formed by a stainless steel device or component. For example, a technical operator may perform pretreatment on an out-field operating stainless steel device or component as needed, and use a pretreated stainless steel device or component as the out-field stainless steel substrate. The pretreatment may include processes such as grinding or polishing. In some embodiments, the out-field stainless steel substrate may be a 304 stainless steel substrate.

The passivation solution container may be configured to contain a passivation solution, the passivation solution being in contact with the out-field stainless steel substrate. The passivation solution may be a chemical solution containing an oxidizing agent. For example, the passivation solution may be a passivation solution for stainless steel such as sulfuric acid, nitric acid, sodium dichromate, potassium dichromate, hydrogen peroxide, benzotriazole, bipyridine, etc.

In some embodiments, the passivation solution container may be fabricated by 3D printing, mold forming, or other manufacturing processes. In some embodiments, the passivation solution container may include a gasket, a rubber ring, etc. It should be understood that a structural dimension and shape of the passivation solution container may be set according to practical requirements. For example, as shown in FIG. 1, the passivation solution container may be configured as a circular ring structure to ensure uniform coverage of the passivation solution on a surface of a metal substrate. In some embodiments, a height of the passivation solution container may be in a range of 0.1 mm-5 mm, and preferably 0.5 mm.

As shown in FIG. 2, the passivation solution container may be closely attached to the out-field stainless steel substrate such that the passivation solution contained therein is in direct contact with a surface of the out-field stainless steel substrate. After the passivation solution contacts the out-field stainless steel substrate, a passivation process is induced. The passivation process refers to a process in which the out-field stainless steel substrate forms a stable passivation membrane on the surface through an electrochemical process (e.g., oxidation) under the action of the passivation solution.

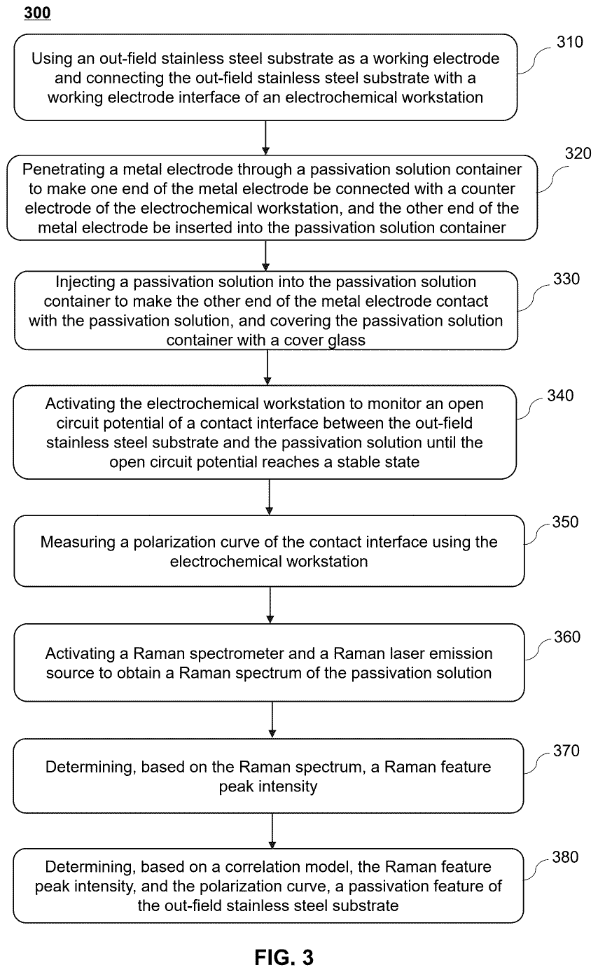

The cover glass may be configured to seal the passivation solution container to maintain stability of the passivation solution and prevent air ingress and external contamination. For example, the passivation solution may be dropped into the passivation solution container and then flattened using the cover glass. In some embodiments, the cover glass may be a microscope cover glass, such as a glass cover slip used in the laboratory. In some embodiments, the cover glass may be made of quartz glass, high-transmittance glass, or other light-transmitting materials. More descriptions regarding sealing the passivation solution container may be found in FIG. 3 and the related descriptions thereof.

The peristaltic pump refers to a pump device configured to transport the passivation solution. For example, the peristaltic pump may include a pump head, the peristaltic pump passivation solution inlet pipe, the peristaltic pump passivation solution outlet pipe, a drive motor configured to drive the pump head, etc. The peristaltic pump may be in fluid communication with the passivation solution container through the peristaltic pump passivation solution inlet pipe and the peristaltic pump passivation solution outlet pipe, and may be configured to control flow of the passivation solution to provide a driving force for exchanging the passivation solution. For example, after the peristaltic pump is activated, the passivation solution may be driven to flow into the passivation solution container from the peristaltic pump passivation solution inlet pipe under the driving force of the peristaltic pump. The passivation solution may flow out of the passivation solution container through the peristaltic pump passivation solution outlet pipe, so as to realize exchange of the passivation solution and maintain stability of components of the passivation solution.

In some embodiments, the pump head of the peristaltic pump may be internally provided with a flexible pump tube and rollers. The rollers may be driven by the drive motor to rotate and squeeze the pump tube to generate a peristaltic transport effect.

The flow of the passivation solution may be controlled through the peristaltic pump passivation solution inlet pipe and the peristaltic pump passivation solution outlet pipe which are connected to two ends of the pump tube, respectively.

The peristaltic pump passivation solution inlet pipe refers to a pipe that transport the passivation solution to the passivation solution container. The peristaltic pump passivation solution outlet pipe refers to a pipe that discharges the passivation solution from the passivation solution container. In some embodiments, the peristaltic pump passivation solution inlet pipe and the peristaltic pump passivation solution outlet pipe may be hoses, such as silicone hoses, plastic hoses, or the like.

In some embodiments, the peristaltic pump may be in fluid communication with the passivation solution container through the peristaltic pump passivation solution inlet pipe and the peristaltic pump passivation solution outlet pipe. For example, as shown in FIGS. 1-2, the peristaltic pump passivation solution inlet pipe 108 and the peristaltic pump passivation solution outlet pipe 109 may be respectively located at two sides of the passivation solution container 102. The two sides of the passivation solution container 102 may be pre-configured with a fluid interface, respectively, such as an L-type or straight-through joint. The peristaltic pump passivation solution inlet pipe 108 and the peristaltic pump passivation solution outlet pipe 109 may be respectively connected to a fluid interface to achieve fluid communication with the passivation solution container.

The electrochemical workstation refers to an electronic instrument configured to control and measure an electrode potential and current during a passivation process. In some embodiments, the electrochemical workstation may be designed in a portable manner to adapt to the out-field environment. For example, the electrochemical workstation may integrate a potentiostat, a galvanostat, and electrochemical impedance spectroscopy (EIS).

In some embodiments, the electrochemical workstation may be configured to apply a dynamic potential to the out-field stainless steel substrate and measure a polarization curve. The dynamic potential refers to an electrode potential that gradually changes over time. For example, a processing device in the out-field detection device may be configured to set a starting potential and a terminal potential. A gradually changing dynamic potential may be applied to the out-field stainless steel substrate between the starting potential and the terminal potential by using the potentiostat in the electrochemical workstation. The starting potential and the terminal potential may be preset based on requirements. More descriptions regarding the processing device may be found in FIG. 1 and the related descriptions thereof.

The polarization curve refers to a curve that records a relationship between the applied dynamic potential and a corresponding current density. More descriptions regarding the polarization curve may be found in FIG. 3 and the related descriptions thereof.

In some embodiments, the electrochemical workstation may be provided with a working electrode interface a, and the working electrode interface a may be configured to establish electrical connection between the electrochemical workstation and the out-field stainless steel substrate. For example, the out-field stainless steel substrate may serve as a working electrode to be connected with the working electrode interface a, so as to establish the electrical connection between the electrochemical workstation and the out-field stainless steel substrate. For example, the working electrode interface a may be electrically connected with the out-field stainless steel substrate through a device such as a wire, a clamp, a probe, or the like, thereby enabling the electrochemical workstation to apply the dynamic potential to the out-field stainless steel substrate through the electrical connection.

In some embodiments, the electrochemical workstation may be further provided with a reference electrode interface b and a counter electrode interface c. The reference electrode interface b may be configured to be electrically connected with the reference electrode, and the counter electrode interface c may be configured to be electrically connected with the counter electrode. The reference electrode and the counter electrode may be conductively connected with the metal electrode, respectively. The metal electrode may penetrate through the passivation solution container to contact with the passivation solution.

The counter electrode interface c refers to a port in the electrochemical workstation that is connected to the counter electrode. The counter electrode refers to an auxiliary electrode that forms a current path together with the working electrode. For example, the counter electrode may be a platinum electrode or a graphite rod electrode.

The reference electrode interface b refers to a port in the electrochemical workstation that is connected to the reference electrode. The reference electrode may be configured to provide a stable reference potential and measure a potential variation of the working electrode. For example, the reference electrode may be a saturated calomel electrode.

The metal electrode refers to an electrode made of a metal material and inserted into the passivation solution. The metal electrode may be a platinum wire or a silver wire. In some embodiments, a technical operator may allow the metal electrode to penetrate through the passivation solution container to make one end of the metal electrode be connected with the counter electrode and/or the reference electrode of the electrochemical workstation, and the other end of the metal electrode be inserted into the passivation solution container, so as to achieve contact between the metal electrode and the passivation solution. More descriptions may be found in FIG. 3 and the related descriptions thereof.

In some embodiments of the present disclosure, by electrically connecting the counter electrode interface with the counter electrode, conductively connecting the counter electrode with the metal electrode, and allowing the metal electrode to contact the passivation solution, current can be transmitted from the working electrode to the metal electrode, which reduces unnecessary potential drift and signal noise, thereby reducing potential drop and improving current transmission efficiency.

The Raman laser emission source refers to a component configured to emit laser light. The laser light emitted from the Raman laser emission source is directed toward the passivation solution and excite substances in the passivation solution to generate Raman scattered light. For example, the Raman laser emission source may emit the laser light with wavelengths including 532 nm, 785 nm, or the like.

In some embodiments, during a dynamic potential scan test performed by the electrochemical workstation, the Raman laser emission source may emit the laser light at a fixed time interval to obtain a Raman scattered signal during the passivation process, thereby realizing component evolution detection in the passivation process.

In some embodiments, the fixed time interval at which the Raman laser emission source emits the laser light may be preset based on prior knowledge. For example, the fixed time interval may be that the Raman laser emission source activated every 2-3 minutes.

The Raman spectrometer refers to an analytical instrument configured to perform Raman spectrometry. For example, the Raman spectrometer may include a laser light emission module, an optical lens, and a spectral detection module. In some embodiments, a technical operator may use a portable Raman spectrometer or a handheld Raman spectrometer based on requirements. In some embodiments, the Raman laser emission source and the Raman spectrometer may adopt a separated structure. For example, the Raman laser emission source may be configured to emit the laser light, and the Raman spectrometer may be configured to perform spectral detection. In some embodiments, the Raman laser emission source may be integrated into the Raman spectrometer. For example, the Raman laser emission source may be a built-in laser light emission module of the Raman spectrometer.

In some embodiments, the Raman spectrometer may be configured to obtain a Raman spectrum of the passivation solution by monitoring the passivation solution. For example, the optical lens of the Raman spectrometer may be moved to and focused at a geometric center of the passivation solution container, and the passivation solution may be monitored in a static scanning mode or a dynamic scanning mode. The static scanning mode refers to single or multiple acquisitions of the Raman spectrum of the passivation solution at one or more time points. The dynamic scanning mode refers to near-real-time acquisition of the Raman spectrum at a relatively short time interval or relatively high frequency. More descriptions regarding obtaining the Raman spectrum may be found in FIG. 3 and the related descriptions thereof.

In some embodiments, as shown in FIG. 2, the out-field detection device may further include an environmental detector 113. The environmental detector may be configured to obtain environmental data. For example, the environmental detector may obtain environmental data under the out-field environment, including an ambient temperature, an ambient vibration, an ambient light intensity, etc. Accordingly, the environmental detector may include a first temperature sensor, a vibration sensor, and a light sensor. In some embodiments, the environmental detector may be a portable device. For example, the environmental detector may integrate the first temperature sensor, the vibration sensor, and the light sensor. In some embodiments, different types of sensors may be disposed at different positions in the out-field environment.

The environmental data refers to data related to the out-field environment. For example, the environmental data may include the ambient temperature, the ambient vibration, and the ambient light intensity in the out-field environment.

In some embodiments, the first temperature sensor in the environmental detector may be configured to detect the ambient temperature; the vibration sensor may be configured to detect the ambient vibration; and the light sensor may be configured to detect the ambient light intensity.

In some embodiments of the present disclosure, the out-field environment is uncontrollable and prone to fluctuations. For example, the dynamic potential applied by the electrochemical workstation may be affected by a temperature variation, and the vibration in the out-field environment may affect the contact stability of the electrode, resulting in a current fluctuation. By using the environmental detector, the ambient temperature, the ambient vibration, and ambient light intensity in the out-field environment may be monitored in real time, so as to prevent harsh out-field conditions, such as high temperature, strong vibration, and intense light interference in industrial scenarios, from affecting the operation of the out-field detection device.

In some embodiments, as shown in FIG. 2, the out-field detection device may further include a detection instrument 114.

The detection instrument refers to an instrument configured to detect the out-field stainless steel substrate after passivation is completed, and may be configured to obtain a detection feature related to the passivation membrane of the out-field stainless steel substrate. For example, the detection instrument may include an optical microscope, a white light interferometer, a scanning electron microscope, etc. After passivation is completed, the passivation membrane is formed on a surface of the out-field stainless steel substrate. The passivation membrane may be composed of chromium oxide (Cr₂O₃), iron oxide (Fe₂O₃), etc. The detection feature may include a thickness of the passivation membrane, a surface roughness, or the like.

In some embodiments, an image of a cross-section of the out-field stainless steel substrate after passivation may be obtained using the optical microscope in the detection instrument, and the thickness of the passivation membrane may be measured based on the image. White light may be emitted to a surface of the passivation membrane using the white light interferometer to scan the surface of the passivation membrane, and acquire height variation data of the surface of the passivation membrane. The surface roughness of the passivation membrane may be determined based on the height variation data.

In some embodiments of the present disclosure, by introducing the detection instrument, the out-field detection device may perform a more comprehensive detection on the passivation membrane of the stainless steel substrate after passivation, thereby improving the real-time performance and accuracy of the detection.

In some embodiments, as shown in FIG. 2, the out-field detection device may be further provided with a second temperature sensor 115, a third temperature sensor 116, and a vibration sensor 117. The second temperature sensor may be configured to obtain a passivation solution temperature of the passivation solution. The second temperature sensor may be disposed on the passivation solution container. For example, the second temperature sensor may be disposed inside the passivation solution container to directly measure the passivation solution temperature, or mounted on an outer wall of the passivation solution container to indirectly measure the passivation solution temperature. The third temperature sensor may be configured to obtain a stainless steel temperature of the out-field stainless steel substrate. In some embodiments, the third temperature sensor may be disposed at a position of the out-field stainless steel substrate close to the passivation solution container. For example, the third temperature sensor may be attached to a surface of the out-field stainless steel substrate at a position close to the passivation solution container to obtain the stainless steel temperature of the out-field stainless steel substrate in real time.

The vibration sensor may be configured to obtain vibration data of the out-field detection device. For example, the vibration sensor may obtain the vibration data including a vibration amplitude, a vibration frequency, a vibration direction, etc., of the out-field detection device. In some embodiments, the vibration sensor may be disposed on the out-field stainless steel substrate. For example, the vibration sensor may be mounted on the surface of the out-field stainless steel substrate by adhesion, bolt fastening, magnetic attachment, or embedded mounting, so as to obtain the vibration data of the out-field stainless steel substrate in real time.

In some embodiments of the present disclosure, considering that the operation of the out-field detection device may be affected by a plurality of factors such as temperature and vibration, the second temperature sensor, the third temperature sensor, and the vibration sensor are introduced to obtain the passivation solution temperature, the stainless steel temperature, and the vibration data of the out-field detection device in real time. Accordingly, more accurate and comprehensive monitoring of the out-field detection device may be achieved, thereby improving the detection accuracy of the out-field detection device.

In some embodiments, the out-field detection device may further include a processing device 118. The processing device may be configured to process data and/or information from various components in the out-field detection device and/or external data sources. In some embodiments, the processing device may execute program instructions based on the data, information, and/or processing results to perform one or more functions described in the present disclosure. For example, the processing device may perform one or more operations in processes 300, 700, 800, or 900.

In some embodiments, the processing device may be a single server or a server group. The server group may be centralized or distributed. In some embodiments, the processing device may be local or remote. In some embodiments, the processing device may be implemented on a cloud platform. Merely by way of example, the cloud platform may include a private cloud, a public cloud, a hybrid cloud, a community cloud, a distributed cloud, an internal cloud, a multi-layer cloud, or any combination thereof. In some embodiments, the processing device may be a field programmable gate array (FPGA) or a digital signal processor (DSP). In some embodiments, the processing device may be integrated into or mounted on the out-field detection device.

In some embodiments of the present disclosure, the out-field detection device disclosed herein may perform accurate and real-time tracking of the passivation process of the out-field stainless steel substrate at a low cost. The out-field stainless steel substrate only needs to undergo simple pretreatment such as grinding and polishing. The size of the passivation solution container may be flexibly customized using a 3D printing technique to meet different requirements for out-field detection, which effectively reduces implementation costs and provides high flexibility. By introducing the Raman laser emission source and the Raman spectrometer, component information in the passivation solution may be analyzed, making the detection environment more consistent with actual corrosion environments, which achieves more realistic reflection of the passivation and corrosion behavior of stainless steel materials and efficiently and accurately realizes in-situ, real-time, and quantitative detection of the out-field stainless steel substrate.

FIG. 3 is a flowchart illustrating an exemplary method for detecting a passivation feature of stainless steel according to some embodiments of the present disclosure. As shown in FIG. 3, a process 300 may include the following operations.

In some embodiments, operations 310-330 may be performed by a technical operator.

In 310, an out-field stainless steel substrate may be used as a working electrode and the out-field stainless steel substrate may be connected with a working electrode interface of an electrochemical workstation.

For example, the electrochemical workstation may be provided with the working electrode interface, and the working electrode interface may be electrically connected with the out-field stainless steel substrate via a device such as a wire, a clamp, a probe, or the like.

In 320, a metal electrode may penetrate through a passivation solution container to make one end of the metal electrode be connected with a counter electrode of the electrochemical workstation, and the other end of the metal electrode be inserted into the passivation solution container.

For example, a through-hole may be formed in a side wall of the passivation solution container, and the metal electrode (e.g., a platinum wire or a silver wire) may penetrate through the through-hole. One end of the metal electrode located outside the passivation solution container may be connected to a reference electrode and the counter electrode, and the other end of the metal electrode may be inserted into the passivation solution container. A diameter of the through-hole may be greater than a diameter of the metal electrode.

In 330, a passivation solution may be injected into the passivation solution container to make the other end of the metal electrode contact with the passivation solution, and the passivation solution container may be covered with a cover glass

In some embodiments, a technical operator may inject the passivation solution into the passivation solution container. For example, the technical operator may prepare a mixed solution of 0.5 mol/L sulfuric acid (H₂SO₄) and 0.01 mol/L bipyridine in advance as the passivation solution, and drop the prepared passivation solution into the passivation solution container using a pipette, so as to allow the passivation solution to contact the other end of the metal electrode. An upper opening of the passivation solution container may be sealed using the cover glass to prevent external contaminants from entering the passivation solution container and reduce evaporation of the passivation solution.

In some embodiments, operations 340-380 may be performed by the processing device in the out-field detection device.

In 340, the electrochemical workstation may be activated to monitor an open circuit potential of a contact interface between the out-field stainless steel substrate and the passivation solution until the open circuit potential reaches a stable state.

In some embodiments, the electrochemical workstation may be activated by the processing device. For example, after the working electrode, the reference electrode, and the counter electrode are respectively connected to corresponding interfaces of the electrochemical workstation, the processing device may turn on a power switch of the electrochemical workstation. In some embodiments, the electrochemical workstation may be manually activated by a user.

The open circuit potential refers to a potential difference naturally formed between the working electrode (i.e., the out-field stainless steel substrate) and the passivation solution under a condition where no potential is applied to the out-field stainless steel substrate.

In some embodiments, the electrochemical workstation may be configured to monitor the open circuit potential until the open circuit potential reaches the stable state. For example, in order to ensure the stability of the contact interface formed between the out-field stainless steel substrate and the passivation solution, the electrochemical workstation may monitor the open circuit potential for at least 30 minutes. The stable state of the open circuit potential may be preset based on prior knowledge. For example, when a potential fluctuation within a preset field of view is less than +2 mV, the open circuit potential is considered to reach the stable state.

In 350, a polarization curve of the contact interface may be measured using the electrochemical workstation.

The contact interface refers to an interface formed between the out-field stainless steel substrate and the passivation solution.

In some embodiments, the processing device may control the electrochemical workstation to apply a dynamic potential to the out-field stainless steel substrate, and perform a scan test at a scan rate while recording a current density. The polarization curve may be obtained based on the potential and the current density corresponding to each scan test. The scan rate refers to a rate at which the potential changes over time. For example, the scan rate may be 2 mV/s. The current density may be determined based on a ratio of the current to a surface area of the out-field stainless steel substrate. For example, the processing device may use the ratio of the current to the surface area of the out-field stainless steel substrate as the current density. More descriptions regarding applying dynamic potential to the out-field stainless steel substrate may be found in FIG. 1 and the related descriptions thereof.

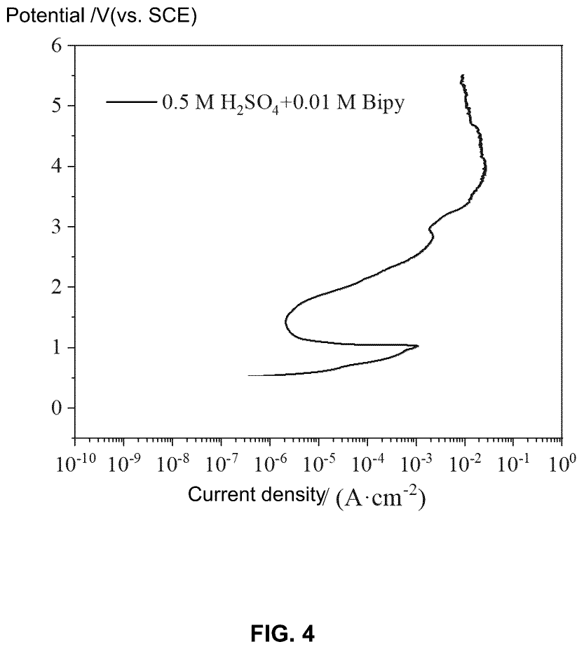

FIG. 4 is a schematic diagram illustrating an exemplary polarization curve according to some embodiments of the present disclosure. As shown in FIG. 4, the polarization curve may reflect a current density at a contact interface between an out-field stainless steel substrate and a passivation solution under different potentials. A vertical axis of the polarization curve represents a potential applied to the out-field stainless steel substrate, and a horizontal axis of the polarization curve represents the current density.

In 360, a Raman spectrometer and a Raman laser emission source may be activated to obtain a Raman spectrum of the passivation solution.

The Raman spectrum refers to a spectrum generated based on an interaction between laser light and the passivation solution. The Raman spectrum obtained by a Raman spectrometer may be acquired by the processing device. For example, a technical operator may move an optical lens of the Raman spectrometer to a geometric center of a passivation solution container and complete focusing. The processing device may control the Raman laser emission source to emit the laser light toward the passivation solution to excite substances in the passivation solution to generate Raman scattered light. The Raman spectrometer may detect the Raman scattered light to obtain the Raman spectrum of the passivation solution.

In some embodiments, the Raman spectrometer may obtain the Raman spectrum through a plurality of acquisitions in a static scanning mode at a fixed time interval, or obtain the Raman spectrum through a real-time acquisition in a dynamic scanning mode. More descriptions regarding the fixed time interval, the static scanning mode, and the dynamic scanning mode may be found in FIG. 1 and the related descriptions thereof.

In 370, a Raman feature peak intensity may be determined based on the Raman spectrum.

The Raman feature peak intensity refers to a maximum Raman signal intensity value at a feature peak corresponding to a component of the passivation solution in the Raman spectrum. For the Raman spectrum obtained through the plurality of acquisitions or the real-time acquisition, the processing device may respectively determine a Raman feature peak intensity corresponding to each Raman spectrum.

In some embodiments, the processing device may determine the Raman feature peak intensity based on the Raman spectrum. For example, if a Raman shift of a component in the passivation solution is 550 cm⁻¹, the processing device may set a feature wavenumber window near 550 cm⁻¹ and extract a maximum intensity value within the window from the acquired the Raman spectrum as the Raman feature peak intensity of the component. The feature wavenumber window may be set based on prior experience. For example, the feature wavenumber window may be in a range of 540-560 cm⁻¹. When the passivation solution contains a plurality of components, the processing device may determine Raman feature peak intensities corresponding to at least a portion (e.g., each) of the components.

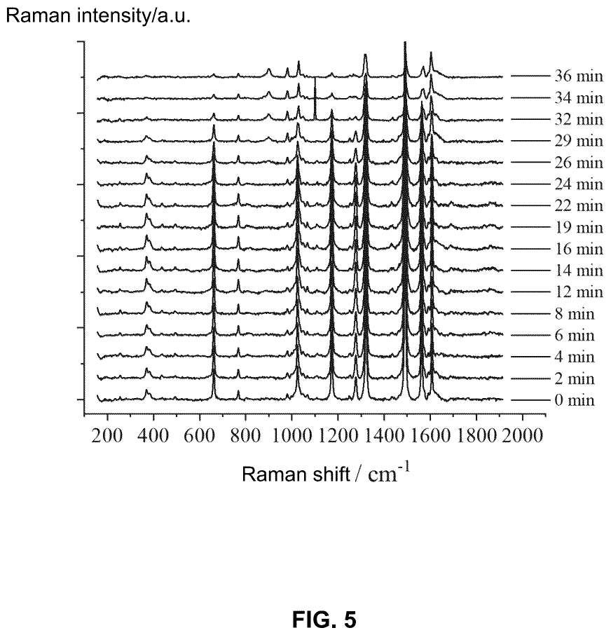

FIG. 5 is a schematic diagram illustrating an exemplary Raman spectrum according to some embodiments of the present disclosure. The Raman spectrum in FIG. 5 is obtained by monitoring a passivation process of 304 stainless steel in a passivation solution composed of 0.5 mol/L H₂SO₄ and 0.01 mol/L bipy.

As shown in FIG. 5, the vertical axis represents a Raman intensity and the horizontal axis represents a Raman shift. Each spectral line corresponds to a Raman spectrum signal collected at a specific time point during the passivation process. The time point may include but is not limited to 0 minutes, 2 minutes, 4 minutes, . . . up to 36 minutes. As shown in FIG. 5, with time progression, some feature peaks (e.g., around 1000 cm⁻¹ and 1400 cm⁻¹) show a trend of increasing intensity, indicating that the corresponding components of the passivation solution are continuously accumulating or increasing in content during the passivation process. Appearance and disappearance of a Raman feature peak corresponding to a component over time may indicate generation and consumption of the component during the passivation process.

In 380, a passivation feature of the out-field stainless steel substrate may be determined based on a correlation model, the Raman feature peak intensity, and the polarization curve.

In some embodiments, the correlation model may be a linear relationship model. In some embodiments, the correlation model may represent a correspondence between a plurality of Raman feature peak intensities and a plurality of standard solution concentrations.

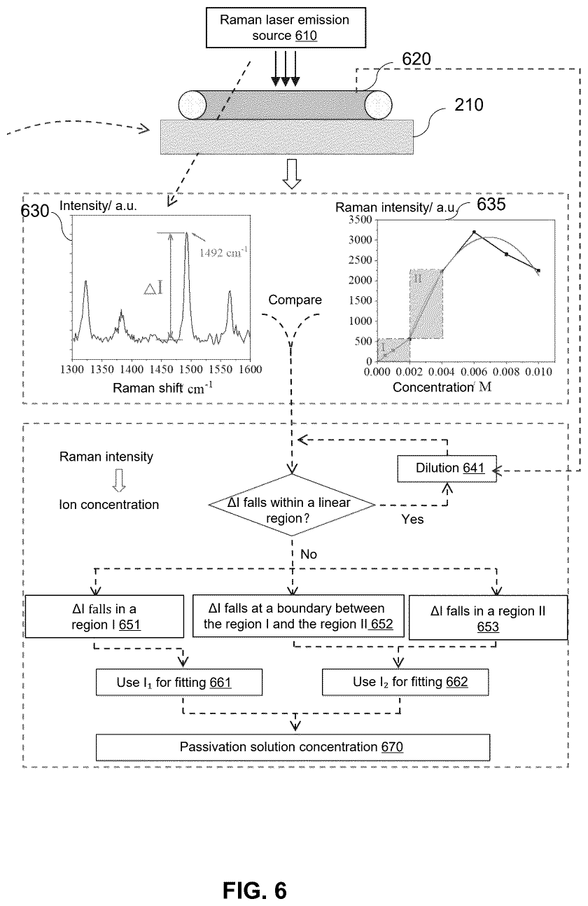

In some embodiments, a technical operator may prepare a series of standard solutions with different concentrations in advance based on requirements and respectively measure a Raman feature peak intensity of each standard solution to establish the correlation model. For example, as shown in FIG. 6, a standard curve may be plotted using the standard solution concentration as a horizontal axis and the Raman feature peak intensity as a vertical axis to establish a correlation model 635. The concentration described in the present disclosure refers to a concentration of one or more substances in a solution, such as a concentration of ions (e.g., divalent iron ions, Cr³⁺ ions, Ni²⁺ ions, etc.), oxides (e.g., FeOOH, and Cr₂O₃), or the like.

With further reference to FIG. 6, the curve of the correlation model includes two linear regions (i.e., a region I and a region II), and in each region, a corresponding mathematical relationship equation is obtained by fitting using linear regression. For example, mathematical relationship equations of the region I and the region II may be respectively represented by Equation (1) and Equation (2):

$${I}_{1} = {k}_{I} \times {c}_{1} + {b}_{1} \qquad ( 1 )$$

$${I}_{2} = {k}_{II} \times {c}_{2} + {b}_{2} \qquad ( 2 )$$

where I₁ and I₂ respectively represent Raman feature peak intensities corresponding to the region I and the region II, c₁ and c₂ respectively represent standard solution concentrations in the region I and the region II, k_{I} and k_{II} respectively represent linear regression slopes in the region I and the region II, and b₁ and b₂ respectively represent linear regression intercepts in the region I and the region II. k_{I}, k_{II}, b₁ and b₂ are obtained through curve fitting. For example, if standard solutions of [Fell(bipy)₃]²⁺ with different concentrations are prepared and Raman intensities at 1492 cm⁻¹ are measured, k_{I} and k_{II} of 2.84×10⁵ and 9.83×10⁵, and b₁ and b₂ of −8.02 and −1440.9 are obtained, respectively by the curve fitting.

The passivation feature refers to a feature related to the passivation process of the out-field stainless steel substrate. For example, the passivation feature may include a passivation solution concentration, a passivation stage of the out-field stainless steel substrate, a corrosion rate, a thickness of the passivation membrane, a surface roughness of the passivation membrane, a passivation effect, or the like.

In some embodiments, the processing device may determine the passivation feature of the out-field stainless steel substrate based on the correlation model, the Raman feature peak intensity, and the polarization curve. For example, the processing device may compare a measured Raman feature peak intensity corresponding to the passivation solution with the correlation model to determine a standard solution concentration corresponding to the measured Raman feature peak intensity, and use the standard solution concentration as the passivation solution concentration of the passivation solution. In combination with the passivation solution concentration and the current density in the polarization curve, the passivation feature of the stainless steel substrate may be determined. In some embodiments, the passivation solution concentration determined based on the correlation model may serve as one passivation feature.

In some embodiments, the processing device may determine the passivation feature of the out-field stainless steel substrate based on the passivation solution concentration and the current density in the polarization curve. Specifically, the processing device may continuously measure the Raman feature peak intensity at a plurality of time points and determine a variation trend of the passivation solution concentration, and determine, based on the variation trend of the passivation solution concentration and a variation trend of the current density, a generation state of the passivation membrane. For example, when concentrations of metal oxides/hydroxides (e.g., FeOOH, and Cr₂O₃) begin to increase and the current density suddenly decreases, the passivation membrane is in a formation stage; when concentrations of corrosion products (e.g., Fe³⁺, and Cr³⁺ ions) or environmental ions (e.g., Cl⁻) increase and the current density sharply rises, the passivation membrane is in a rupture stage; when concentrations of metal ions (e.g., Fe²⁺, and Ni²⁺) increase and the current density increases with the potential, the passivation membrane is in an active dissolution stage. Determining the passivation feature based on both the passivation solution concentration and the current density may improve the accuracy of the determined passivation feature.

FIG. 6 is a schematic diagram illustrating an exemplary process of determining a passivation solution concentration based on a correlation model according to some embodiments of the present disclosure. As shown in FIG. 6, a passivation solution 620 may be in contact with an out-field stainless steel substrate 210. A Raman laser emission source 610 may emit laser light toward the passivation solution 620 to obtain a Raman spectrum 630. An actual Raman feature peak intensity ΔI of the passivation solution 620 at a specific Raman shift (e.g., 1492 cm⁻¹) may be determined based on the Raman spectrum 630.

The measured Raman feature peak intensity ΔI may be compared with the pre-established correlation model 635 to determine a linear region in which the measured Raman feature peak intensity ΔI falls. For example, the processing device may determine the linear region of the correlation model in which the measured Raman feature peak intensity ΔI is located. If ΔI falls in a region I 651 or a region II 653, a concentration may be calculated using a fitting Equation (1) 661 of the region I or a fitting Equation (2) 662 of the region II, respectively. If ΔI falls at a boundary 652 between the region I and the region II, the concentration may be calculated using the fitting Equation (2) 662 of the region II, so as to determine a passivation solution concentration 670 corresponding to the passivation solution 620.

For example, if the measured Raman feature peak intensity ΔI exceeds a maximum linear fitting range defined in the correlation model (e.g., beyond the region II), the processing device may dilute 641 the passivation solution 620, and re-measure, based on the Raman spectrum 630, a new Raman feature peak intensity ΔI of the passivation solution 620 after dilution at the specific Raman shift (e.g., 1492 cm⁻¹). The processing device may compare the new ΔI with the correlation model 635 to determine a linear region in which the new ΔI falls.

In some embodiments of the present disclosure, with the method for detecting the passivation feature of stainless steel, the passivation feature of the out-field stainless steel substrate in an actual service environment can be efficiently and accurately determined. The corrosion behavior of stainless steel can be effectively evaluated and monitored, thereby providing important technical support for safety assessment and protective measures of the out-field detection device.

In some embodiments, the processing device may further determine a concentration variation of the passivation solution based on the correlation model and the Raman feature peak intensity; determine a passivation effect based on the concentration variation of the passivation solution; obtain a detection feature of the out-field stainless steel substrate, the detection feature being obtained by a detection instrument after the out-field stainless steel substrate completes passivation; and determine a corrosion resistance of the out-field stainless steel substrate based on the detection feature and the passivation effect.

In some embodiments, the processing device may determine passivation solution concentrations at a plurality of time points based on the correlation model and Raman feature peak intensities corresponding to the plurality of time points, and determine the concentration variation based on the passivation solution concentrations at the plurality of time points.

The passivation effect is used to evaluate an effect of forming a passivation membrane on a surface of the out-field stainless steel substrate. The passivation effect may be represented in forms such as a numerical value, a level (e.g., good, moderate, poor, etc.), etc. The processing device may determine the passivation effect based on the concentration variation of the passivation solution. For example, if the concentration variation of the passivation solution gradually decreases within a reasonable range, a uniform and dense passivation membrane tends to form, and the passivation effect is considered good. If the concentration shows almost no variation or decreases too rapidly, an insufficient reaction between the passivation solution and the surface of the out-field stainless steel substrate may occur, leading to incomplete formation of the passivation membrane, and the passivation effect is considered poor. The reasonable range may be preset based on prior knowledge.

The detection feature may include a thickness of the passivation membrane and a surface roughness acquired by the detection instrument. More descriptions regarding the detection feature may be found in FIG. 1 and the related descriptions thereof.

In some embodiments, the processing device may perform weighted summation of the detection feature and the passivation effect based on corresponding weighting coefficients to determine the corrosion resistance of the out-field stainless steel substrate. For example, the processing device may extract the thickness of the passivation membrane, the surface roughness, and the passivation effect, convert the thickness of the passivation membrane, the surface roughness, and the passivation effect into respective score values, and perform the weighted summation to obtain a quantified corrosion resistance score, so as to determine the corrosion resistance of the out-field stainless steel substrate. The score value may be positively correlated with the detection feature and the passivation effect. For example, the greater the thickness of the passivation membrane, the higher the score value; the smoother the surface roughness, the higher the score value; the better the passivation effect, the higher the score value.

In some embodiments, weights corresponding to the detection feature and the passivation effect may be preset manually based on experience. The weight assigned to the detection feature may be set higher than the weight assigned to the passivation effect.

In some embodiments, when the corrosion resistance score is lower than a scoring threshold, the out-field detection device may issue a warning to prompt a technical operator to replace the out-field stainless steel substrate, reprocess the surface of the out-field stainless steel substrate, or perform passivation treatment again, so as to ensure long-term and stable operation of the out-field detection device.

In some embodiments of the present disclosure, by combining the detection feature and the passivation effect of the out-field stainless steel substrate, a comprehensive evaluation result of the corrosion resistance of stainless steel can be obtained, which significantly improves the reliability and accuracy of passivation assessment, better aligns with actual application environment requirements, and provides important technical support for safety protection of out-field equipment and optimization of material performance.

It should be noted that the above descriptions regarding the process 300 are merely for purposes of example and illustration, and do not limit the scope applicable to the present disclosure. Various modifications and changes to the process may be made by those skilled in the art in light of the teachings of the present disclosure. However, such modifications and changes still fall within the scope of the present disclosure.

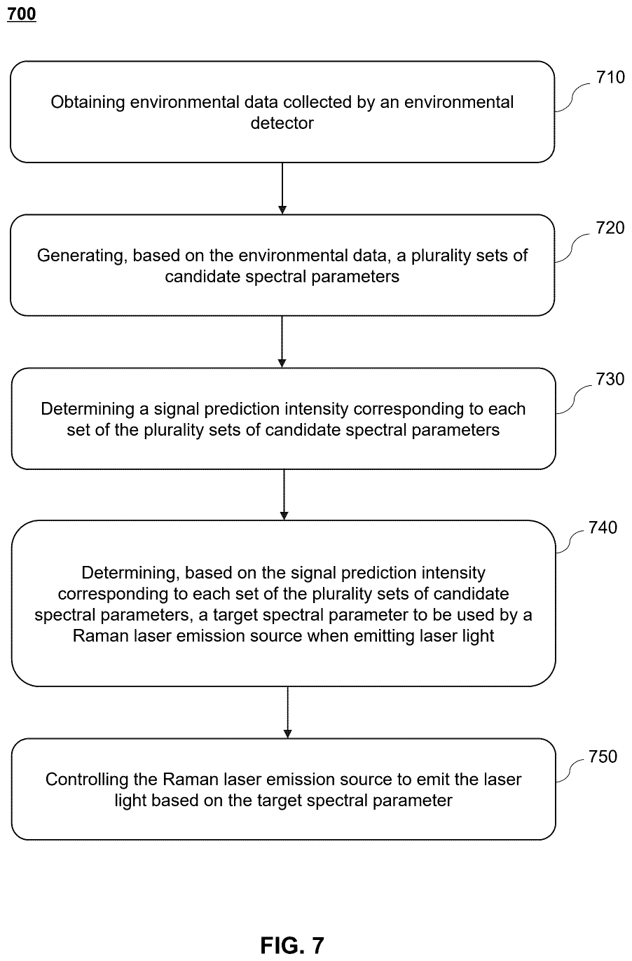

FIG. 7 is a flowchart illustrating an exemplary process of monitoring components of a passivation solution according to some embodiments of the present disclosure. As shown in FIG. 7, a process 700 may include the following operations.

In 710, environmental data collected by an environmental detector may be obtained.

In some embodiments, the environmental data may include an ambient temperature, an ambient vibration, an ambient light intensity, etc. The environmental data may be obtained from the environmental detector in an out-field detection device. For example, the environmental detector may include a plurality of sensors, such as a first temperature sensor, a vibration sensor, a light sensor, etc., configured to respectively collect the ambient temperature, the ambient vibration, the ambient light intensity, etc., in an out-field environment.

In 720, a plurality sets of candidate spectral parameters may be generated based on the environmental data.

The spectral parameters refer to parameters used by a Raman spectrometer when emitting laser light. For example, the spectral parameters may include a laser power, a laser wavelength, a scattering angle, or the like. One set of candidate spectral parameters may include a candidate value of each of the spectral parameters.

In some embodiments, the processing device may generate the candidate spectral parameters in a plurality of ways. For example, the processing device may randomly generate a count of candidate spectral parameters and candidate values of each set of candidate spectral parameters within an allowable variation range.

In some embodiments, generating the plurality sets of candidate spectral parameters may include: determining, based on a difference between the environmental data and standard environmental data, random value ranges and a count of the plurality sets of candidate spectral parameters; and generating, based on the count and the random value ranges, the plurality sets of candidate spectral parameters.

The standard environmental data refers to reference the environmental data collected by the environmental detector under a preset standard environmental condition. For example, the standard environmental data may include a standard ambient temperature, a standard ambient light intensity, and a standard ambient vibration. The standard environmental condition refers to a reference environmental condition under which the spectral parameters are minimally influenced by the environmental data, and may be preset by a technical operator based on specific requirements. For example, the standard environmental condition may be a laboratory condition.

The random value ranges refer to value ranges of the spectral parameters. When a plurality of spectral parameters are provided, a random value range for each of the plurality of spectral parameters needs to be determined. In some embodiments, the processing device may determine the random value ranges of the plurality sets of candidate spectral parameters based on the difference between the environmental data and the standard environmental data. For example, the processing device may determine the random value ranges of the plurality sets of candidate spectral parameters using Equation (3):

$$R ∈ ( X - a , X + b ) \qquad ( 3 )$$

where R represents a value of the candidate spectral parameters, X represents a standard value of the candidate spectral parameters under the standard environmental data, and a and b respectively represent a lower offset and an upper offset of the value ranges of the candidate spectral parameters with the value range centered on the standard value X, and (X−a, X+b) represents the value range of the candidate spectral parameters.

In some embodiments, the values of a and b may be obtained by multiplying a difference between current environmental data and the standard environmental data by preset proportionality factors A and B. For example, the processing device may determine the values of a and b using Equation (4) and Equation (5):

$$a = Difference \times A \qquad ( 4 )$$

$$b = Difference \times B \qquad ( 5 )$$

where Difference represents the difference between the current environmental data and the standard environmental data, and A and B represent the proportionality factors, which may be preset by a technical operator based on prior knowledge. That is, a smaller difference between the environmental data and the standard environmental data indicates that the current environment is closer to the standard environment.

In some embodiments, the difference between the current environmental data and the standard environmental data may be determined by performing weighted summation of a first difference, a second difference, and a third difference. The first difference is a difference between a current ambient temperature and a standard ambient temperature, the second difference is a difference between a current ambient light intensity and a standard ambient light intensity, and the third difference is a difference between a current ambient vibration and a standard ambient vibration. For example, the processing device may determine the difference between the current environmental data and the standard environmental data using Equation (6):

$$Difference = {w}_{1} \times \vert Current ambient temperature - standard ambient temperature \vert + {w}_{2} \times \vert Current ambient light intensity - standard ambient light intensity \vert + {w}_{3} \times \vert Current ambient vibration - standard ambient vibration \vert \qquad ( 6 )$$

where w₁, w₂ and w₃ represent preset weighting coefficients, which may be preset by a technical operator based on prior knowledge.

The count of the plurality sets of candidate spectral parameters may be positively correlated with the difference between the current environmental data and the standard environmental data. For example, the smaller the Difference, the smaller the count of the plurality sets of candidate spectral parameters; the larger the Difference, the larger the count of plurality sets of candidate spectral parameters.

For each of the spectral parameters, after the corresponding random value ranges and the count of the plurality sets of candidate spectral parameters are determined, the processing device may randomly select numerical values within the random value ranges to be used as corresponding candidate spectral parameters. The candidate spectral parameters corresponding to a plurality of spectral parameters may constitute a set of candidate spectral parameters.

In some embodiments of the present disclosure, by utilizing the difference between the current environmental data and the standard environmental data, the count of generated candidate spectral parameters and the corresponding random value ranges may be dynamically adjusted, such that the count and coverage range of generated candidate spectral parameters may be reduced when an environmental variation is relatively small, thereby decreasing the volume of data processing and improving optimization efficiency of the candidate spectral parameters. When the environmental difference is relatively large, the diversity and coverage range of candidate spectral parameters may be increased, enhancing the stability and success rate in obtaining Raman spectrum, thereby making the method suitable for various out-field environmental scenarios.

In 730, a signal prediction intensity corresponding to each set of the plurality sets of candidate spectral parameters may be determined.

The signal prediction intensity refers to an estimated value of a Raman signal intensity. The Raman signal intensity refers to an intensity of scattered light generated by Raman scattering caused by molecular vibration when the laser light is emitted onto the passivation solution or a surface of the out-field stainless steel substrate.

In some embodiments, the processing device may determine the signal prediction intensity corresponding to each set of the plurality sets of candidate spectral parameters in a plurality of ways. For example, the processing device may determine the signal prediction intensity corresponding to each set of the plurality sets of candidate spectral parameters by querying a lookup table based on the plurality sets of candidate spectral parameters. The lookup table may include a correspondence between the plurality sets of spectral parameters and the signal prediction intensities. The lookup table may be pre-constructed based on historical data or prior knowledge.

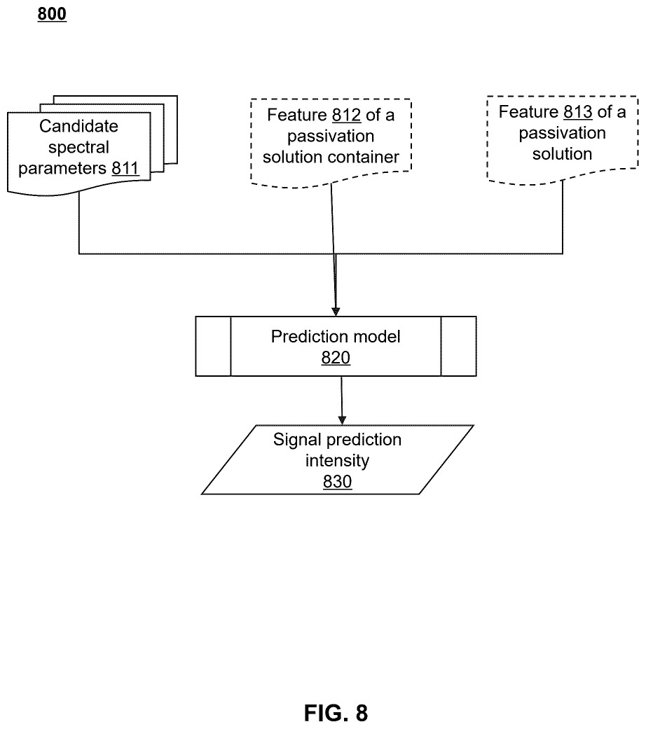

FIG. 8 is a schematic diagram illustrating an exemplary prediction model according to some embodiments of the present disclosure.

In some embodiments, as shown in FIG. 8, determining a signal prediction intensity corresponding to each set of the plurality sets of candidate spectral parameters may include: determining a signal prediction intensity 830 corresponding to each set of the plurality sets of candidate spectral parameters through a prediction model 820 based on each set of candidate spectral parameters 811. The prediction model may be a machine learning model. For example, the prediction model may be a deep neural network (DNN), etc.

In some embodiments, as shown in FIG. 8, an input of the prediction model 820 may include the each set of candidate spectral parameters 811, and an output of the prediction model 820 may include the signal prediction intensity 830 corresponding to each set of the plurality sets of candidate spectral parameters. In some embodiments, as shown in FIG. 8, the input of the prediction model may further include a feature 812 of the passivation solution container and a feature 813 of the passivation solution.

In some embodiments, the feature of the passivation solution container may include a feature related to a size of the passivation solution container, such as a diameter of the passivation solution container, a height of the passivation solution container, a volume of the passivation solution container, etc.

In some embodiments, the feature of the passivation solution may include a feature related to a type of the passivation solution and a composition ratio of the passivation solution. For example, the type of the passivation solution may include a nitric acid-based passivation solution, a dichromate-based passivation solution, or a mixed passivation solution.

The size of the passivation solution container affects a contact area between the out-field stainless steel substrate and the passivation solution, which in turn influences a size of a passivation reaction region. The type and the composition ratio of the passivation solution directly determine the formation efficiency and quality of the passivation membrane, which affects the signal intensity. By using the feature of the passivation solution container and the feature of the passivation solution as inputs of the prediction model, the accuracy of the predicted signal prediction intensity may be improved.

In some embodiments, training samples of the prediction model may include sample candidate spectral parameters, a feature of a sample passivation solution container, and a feature of a sample passivation solution. A label corresponding to each training sample may be a Raman signal intensity detected from the sample passivation solution. The training samples may be determined based on historical data, and the labels corresponding to the training samples may be obtained and annotated manually based on the historical data.

In some embodiments, the prediction model may be obtained by training using a plurality of training samples with labels. The processor may execute the following training process to obtain the prediction model. The training process may include: acquiring a plurality of training samples with labels to form a training sample set and performing a plurality of iterations based on the training sample set. At least one of the iterations may include: selecting one or more training samples from the training data set; inputting the one or more training samples into an initial prediction model to obtain model prediction outputs corresponding to the one or more training samples; substituting the model prediction outputs and the labels corresponding to the one or more training samples into a predefined equation of a loss function to calculate a value of the loss function; and iteratively updating model parameters of the initial prediction model based on the value of the loss function. The iterations may be terminated when an iteration termination condition is satisfied, and a trained prediction model may be obtained. The model parameters of the initial prediction model may be updated using various processes, such as gradient descent. The iteration termination condition may include convergence of the loss function or a count of the iterations reaching a preset threshold.

In some embodiments of the present disclosure, by introducing the prediction model, the Raman signal intensity that may be generated by the candidate spectral parameters under the current environmental condition may be predicted, thereby avoiding an inefficient trial-and-error process and improving resource utilization and data processing efficiency.

In 740, a target spectral parameter to be used by a Raman laser emission source when emitting laser light may be determined based on the signal prediction intensity corresponding to each set of the plurality sets of candidate spectral parameters.

The target spectral parameter refers to a spectral parameter adopted by the Raman laser emission source when emitting the laser light.

In some embodiments, the processing device may determine the target spectral parameter by selecting, among the plurality sets of candidate spectral parameters, a candidate spectral parameter corresponding to a maximum signal prediction intensity based on the signal prediction intensities corresponding to the plurality sets of candidate spectral parameters.

In 750, the Raman laser emission source may be controlled to emit the laser light to the passivation solution based on the target spectral parameter.

In some embodiments of the present disclosure, the environmental data is collected in real time by the environmental detector, and the plurality sets of candidate spectral parameters are generated based on the environmental data, such that an optimal target spectral parameter may be determined based on the signal prediction intensity corresponding to each set of candidate spectral parameters, thereby effectively improving the accuracy of Raman spectrum detection and enhancing the accuracy of detection on the out-field stainless steel substrate.

It should be noted that the above descriptions regarding the process 700 are merely for the purposes of example and illustration, and do not limit the scope applicable to the present disclosure. Various modifications and changes to the process may be made by those skilled in the art in light of the teachings of the present disclosure. However, such modifications and changes still fall within the scope of the present disclosure.

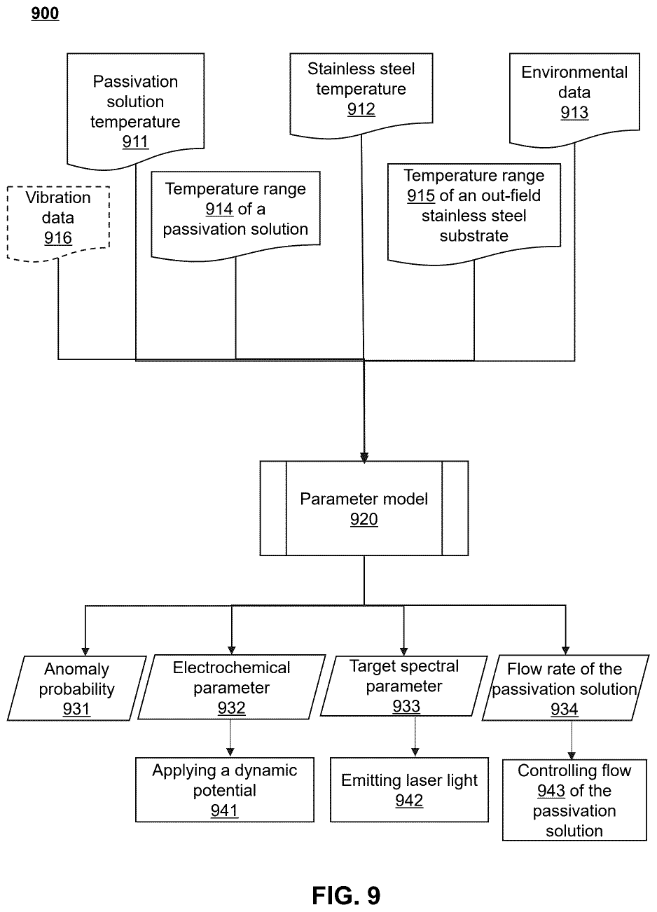

FIG. 9 is a schematic diagram illustrating an exemplary parameter model according to some embodiments of the present disclosure. As shown in FIG. 9, a processing device may obtain a passivation solution temperature 911 collected by a second temperature sensor, a stainless steel temperature 912 collected by a third temperature sensor, and environmental data 913 collected by an environmental detector; determine, based on the passivation solution temperature 911, the stainless steel temperature 912, the environmental data 913, a temperature range 914 of a passivation solution, and a temperature range 915 of an out-field stainless steel substrate, an anomaly probability 931, an electrochemical parameter 932, a target spectral parameter 933, and a flow rate 934 of the passivation solution through a parameter model 920; controlling, based on the electrochemical parameter 932, an electrochemical workstation to apply a dynamic potential 941 to the out-field stainless steel substrate; controlling, based on the target spectral parameter 933, a Raman laser emission source to emit laser light 942 to the passivation solution; and controlling, based on the flow rate 934 of the passivation solution, flow 943 of the passivation solution.

The second temperature sensor may be disposed on a passivation solution container and configured to collect the passivation solution temperature of the passivation solution. The third temperature sensor may be disposed at a position of the out-field stainless steel substrate close to the passivation solution container and configured to collect a stainless steel temperature of the out-field stainless steel substrate. The environmental detector may be configured to obtain the environmental data. The environmental data may include an ambient temperature, an ambient vibration, an ambient light intensity, etc., under an out-field environment. More descriptions regarding the second temperature sensor, the third temperature sensor, and the environmental detector may be found in FIG. 1 and the related descriptions thereof.

The anomaly probability refers to a probability value indicating a deviation of the out-field detection device from a normal state. In some embodiments, the anomaly probability may include a passivation solution anomaly probability and a stainless steel anomaly probability. The passivation solution anomaly probability refers to a probability that an anomaly (e.g., a deviation from a preset temperature range of the passivation solution) occurs in the temperature of the passivation solution. The stainless steel anomaly probability refers to a probability that an anomaly (e.g., a deviation from a preset temperature range of the stainless steel substrate) occurs in the temperature of the out-field stainless steel substrate.

The electrochemical parameter refers to a parameter related to a potential or current used by the electrochemical workstation. For example, the electrochemical parameter may include a dynamic potential scan rate, a starting potential, a terminal potential, etc.

The flow rate of the passivation solution refers to a flow rate of the passivation solution in the passivation solution container.

In some embodiments, the parameter model may be a machine learning model. For example, the parameter model may be a DNN, etc.

In some embodiments, the parameter model may include an anomaly probability prediction layer and a parameter determination layer.

The anomaly probability prediction layer is a model component configured to predict an anomaly probability. The anomaly probability prediction layer may be a machine learning model, such as a DNN. In some embodiments, an input of the anomaly probability prediction layer may include a passivation solution temperature sequence over a preset time period, a stainless steel temperature sequence over the preset time period, and the environmental data, and an output of the anomaly probability prediction layer may include the anomaly probability.

The passivation solution temperature sequence refers to sequential data composed of passivation solution temperatures collected at a plurality of time points within the preset time period. The stainless steel temperature sequence refers to sequential data composed of stainless steel temperatures collected at a plurality of time points within the preset time period. In some embodiments, the second temperature sensor and the third temperature sensor may respectively collect a plurality of passivation solution temperatures and a plurality of stainless steel temperatures at the plurality of time points at a preset sampling interval to obtain the corresponding sequential data. The preset sampling interval refers to a time interval between adjacent sampling time points of the plurality of time points. The passivation solution temperature sequence and the stainless steel temperature sequence may be represented in a vector form. For example, if the passivation solution temperatures collected at 6:10, 6:20, and 6:30 are 28.0° C., 28.2° C., and 28.6° C. respectively, the corresponding passivation solution temperature sequence may be represented as ((6:10, 28.0), (6:20, 28.2), (6:30, 28.6)). The stainless steel temperature sequence is represented in a similar manner, which is not repeated here.

The parameter determination layer refers to a model component configured to determine the electrochemical parameter, the target spectral parameter, and the flow rate of the passivation solution. The parameter determination layer may be a machine learning model, such as a DNN. In some embodiments, an input of the parameter determination layer may include the anomaly probability, the temperature range of the passivation solution, and the temperature range of the out-field stainless steel substrate, and an output of the parameter determination layer may include may include the electrochemical parameter, the target spectral parameter, and the flow rate of the passivation solution. The temperature range of the passivation solution refers to a normal temperature range of the passivation solution, and the temperature range of the out-field stainless steel substrate refers to a normal temperature range of the out-field stainless steel substrate, which may be preset by a technical operator based on prior knowledge.

In some embodiments, the processing device may use a trained anomaly probability prediction layer and a trained parameter determination layer as the parameter model. In some embodiments, the anomaly probability prediction layer and the parameter determination layer may be obtained through joint training.

In some embodiments, a joint training model may be trained based on a large number of training samples and corresponding training labels. Training samples for the anomaly probability prediction layer may include a sample passivation solution temperature sequence, a sample stainless steel temperature sequence, and sample environmental data. The training samples for the anomaly probability prediction layer may be determined based on historical data.

Training samples for the parameter determination layer may include a sample anomaly probability, a sample temperature range of the passivation solution, and a sample temperature range of the out-field stainless steel substrate. The training samples for the parameter determination layer may be determined based on preferred historical data. The preferred historical data refers to a data segment where an anomaly probability at a first historical time is greater than a first anomaly threshold, and an anomaly probability at a second historical time is less than a second anomaly threshold. The second historical time occurs after the first historical time. The first historical time, the second historical time, the first anomaly threshold, and the second anomaly threshold may be preset based on prior knowledge.

The labels corresponding to the training samples for the anomaly probability prediction layer refer to anomaly probabilities corresponding to a sample out-field detection devices from historical data. For example, a sample out-field detection device with a subsequent passivation solution temperature exceeding the temperature range of the passivation solution or a stainless steel temperature exceeding the temperature range of the out-field stainless steel substrate may be selected from the historical data, and a label value of the anomaly probability corresponding to the sample out-field detection device may be set as 1; otherwise, the label value may be set as 0.

The labels corresponding to the training samples for the parameter determination layer may include the electrochemical parameter, the Raman spectral parameters, and the flow rate of the passivation solution from second historical data corresponding to the preferred historical data.

In some embodiments, the processing device may input the sample passivation solution temperature sequence, the sample stainless steel temperature sequence, and the sample environmental data into the anomaly probability prediction layer to obtain the anomaly probability output by the anomaly probability prediction layer; and input the anomaly probability as training sample data along with the sample passivation solution temperature range and the sample stainless steel temperature range into the parameter determination layer to obtain the electrochemical parameter, the target spectral parameter, and the flow rate of the passivation solution output by the parameter determination layer. Parameters of the anomaly probability prediction layer and the parameter determination layer may be synchronously updated based on a sample electrochemical parameter, a sample target spectral parameter, a sample flow rate of the passivation solution, and the electrochemical parameter, the target spectral parameter, and the flow rate of the passivation solution output from the parameter determination layer. The trained anomaly probability prediction and the trained parameter determination layer may be obtained by parameter updating.

In some embodiments, the processing device may control the electrochemical workstation to apply the dynamic potential to the out-field stainless steel substrate based on the electrochemical parameter. More descriptions regarding the electrochemical workstation may be found in FIG. 1 and the related descriptions thereof.

In some embodiments, the processing device may control the Raman laser emission source to emit the laser light to the passivation solution based on the target spectral parameter. More descriptions regarding the Raman laser emission source may be found in FIG. 1 and the related descriptions thereof.

In some embodiments, the processing device may control the flow of the passivation solution through a peristaltic pump based on the flow rate of the passivation solution. More descriptions regarding the peristaltic pump may be found in FIG. 1 and the related descriptions thereof.

In some embodiments of the present disclosure, by determining the electrochemical parameter, the target spectral parameter, and the flow rate of the passivation solution through the parameter model, and automatically controlling the operation of the electrochemical workstation, the Raman laser emission source, and the peristaltic pump, measurement deviations or passivation process failures caused by temperature or vibration anomalies can be effectively avoided, thus enhancing the stability and reliability of the out-field passivation process and reducing the complexity and risk of on-site manual operation.

In some embodiments, as shown in FIG. 9, an input of the parameter model 920 may include vibration data 916 of the out-field detection device, and the anomaly probability 931 may include a vibration anomaly probability (not illustrated in FIG. 9). The processing device may further perform the following operations: determining a device anomaly probability based on the passivation solution anomaly probability, the stainless steel anomaly probability, and the vibration anomaly probability; and in response to the vibration anomaly probability being greater than a first preset threshold or the device anomaly probability being greater than a second preset threshold, stopping operation of the electrochemical workstation and the peristaltic pump, and issuing a warning.

More descriptions regarding the vibration data may be found in FIG. 1 and the related descriptions thereof.

In some embodiments, the input of the anomaly probability prediction layer of the parameter model may include the vibration data of the out-field detection device, and the output anomaly probability may further include the vibration anomaly probability. The vibration anomaly probability refers to a probability of anomaly vibration occurring in the out-field detection device.

The device anomaly probability refers to an overall anomaly probability of the out-field detection device. In some embodiments, the processing device may perform weighted summation of the passivation solution anomaly probability, the stainless steel anomaly probability, and the vibration anomaly probability to determine the device anomaly probability. Weights assigned to the passivation solution anomaly probability, the stainless steel anomaly probability, and the vibration anomaly probability, respectively, may be preset manually based on experience.

In some embodiments, in response to the vibration anomaly probability being greater than the first preset threshold or the device anomaly probability being greater than the second preset threshold, operation of the electrochemical workstation and the peristaltic pump may be stopped, and the warning may be issued. The first preset threshold and/or the second preset threshold may be preset manually based on experience.

In some embodiments, the first preset threshold may be positively correlated with a vibration intensity of an environment where the out-field stainless steel substrate is located. For example, the greater the ambient vibration in the environmental data, the higher the first preset threshold. More descriptions regarding the environmental data may be found in FIG. 1 and the related descriptions thereof.

In some embodiments of the present disclosure, by positively correlating the first preset threshold corresponding to the vibration anomaly probability with the ambient vibration in the environmental data, the greater the ambient vibration, the higher the first preset threshold, the vibration caused by the environment may be differentiated from the vibration caused by the anomaly of the out-field detection device. In this way, misjudging an environmental vibration as the anomaly of the out-field detection device may be avoided, thereby improving the accuracy and reliability of anomaly detection.

In some embodiments of the present disclosure, through comprehensive analysis of various types of anomaly data, various anomalies of the out-field detection device can be comprehensively monitored, significantly improving the safety and reliability of the out-field detection device, and reducing operation and maintenance costs and onsite operation risks of the out-field detection device, thereby realizing long-term stable application of the out-field detection device in complex out-field environments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%.

Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. An out-field detection device, comprising an out-field stainless steel substrate, a passivation solution container, a cover glass, an electrochemical workstation, a Raman spectrometer, a Raman laser emission source, and a peristaltic pump, wherein:
the passivation solution container is configured to contain a passivation solution, the passivation solution being in contact with the out-field stainless steel substrate;
the cover glass is configured to seal the passivation solution container;
the peristaltic pump is in fluid communication with the passivation solution container through a peristaltic pump passivation solution inlet pipe and a peristaltic pump passivation solution outlet, and is configured to control flow of the passivation solution;
the electrochemical workstation is configured to apply a dynamic potential to the out-field stainless steel substrate and measure a polarization curve, the electrochemical workstation is provided with a working electrode interface, and the working electrode interface is configured to establish electrical connection between the electrochemical workstation and the out-field stainless steel substrate;
the Raman laser emission source is configured to emit laser light toward the passivation solution;
the Raman spectrometer is configured to obtain a Raman spectrum of the passivation solution by monitoring the passivation solution.

2. The out-field detection device of claim 1, wherein the electrochemical workstation is further provided with a counter electrode interface, the counter electrode interface is electrically connected with a counter electrode, the counter electrode is conductively connected with a metal electrode; the metal electrode penetrates through the passivation solution container to contact with the passivation solution.

3. The out-field detection device of claim 1, further comprising an environmental detector; wherein the environmental detector is configured to obtain environmental data, the environmental data including an ambient temperature, an ambient vibration, and an ambient light intensity.

4. The out-field detection device of claim 1, further comprising a detection instrument, wherein the detection instrument is configured to obtain a detection feature correlated with a passivation membrane of the out-field stainless steel substrate after the out-field stainless steel substrate completes passivation.

5. The out-field detection device of claim 1, further comprising a second temperature sensor, a third temperature sensor, and a vibration sensor, wherein:
the second temperature sensor is disposed on the passivation solution container and configured to obtain a passivation solution temperature of the passivation solution;
the third temperature sensor is disposed at a position of the out-field stainless steel substrate close to the passivation solution container and configured to obtain a stainless steel temperature of the out-field stainless steel substrate; and
the vibration sensor is disposed on the out-field stainless steel substrate and configured to obtain vibration data of the out-field detection device.

6. A method for detecting a passivation feature of stainless steel, comprising:
using an out-field stainless steel substrate as a working electrode and connecting the out-field stainless steel substrate with a working electrode interface of an electrochemical workstation;
penetrating a metal electrode through a passivation solution container to make one end of the metal electrode be connected with a counter electrode of the electrochemical workstation, and the other end of the metal electrode be inserted into the passivation solution container;
injecting a passivation solution into the passivation solution container to make the other end of the metal electrode contact with the passivation solution, and covering the passivation solution container with a cover glass;
activating the electrochemical workstation to monitor an open circuit potential of a contact interface between the out-field stainless steel substrate and the passivation solution until the open circuit potential reaches a stable state;
measuring a polarization curve of the contact interface using the electrochemical workstation;
activating a Raman spectrometer and a Raman laser emission source to obtain a Raman spectrum of the passivation solution;
determining, based on the Raman spectrum, a Raman feature peak intensity;
determining, based on a correlation model, the Raman feature peak intensity, and the polarization curve, a passivation feature of the out-field stainless steel substrate, the correlation model representing a correspondence between a plurality of Raman feature peak intensities and a plurality of standard solution concentrations, and each of the standard solution concentrations not exceeding 0.1 M.

7. The method of claim 6, wherein the method is applicable to detect stainless steel containing iron, chromium, and nickel.

8. The method of claim 6, further comprising:
obtaining environmental data collected by an environmental detector, the environmental data including an ambient temperature, an ambient vibration, and an ambient light intensity;
generating, based on the environmental data, a plurality sets of candidate spectral parameters;
determining a signal prediction intensity corresponding to each set of the plurality sets of candidate spectral parameters;
determining, based on the signal prediction intensity corresponding to each set of the plurality sets of candidate spectral parameters, a target spectral parameter to be used by the Raman laser emission source when emitting laser light, the target spectral parameter including a laser power, a laser wavelength, and a scattering angle; and
controlling the Raman laser emission source to emit the laser light based on the target spectral parameter.

9. The method of claim 8, wherein the generating, based on the environmental data, a plurality sets of candidate spectral parameters includes:
determining, based on a difference between the environmental data and standard environmental data, random value ranges and a count of the plurality sets of candidate spectral parameters; and
generating, based on the count and the random value ranges, the plurality sets of candidate spectral parameters.

10. The method of claim 8, wherein the determining a signal prediction intensity corresponding to each set of the plurality sets of candidate spectral parameters includes:
determining, based on each set of the plurality sets of candidate spectral parameters, the signal prediction intensity corresponding to each set of the plurality sets of candidate spectral parameters through a prediction model, the prediction model being a machine learning model.

11. The method of claim 10, wherein an input of the prediction model includes a feature of the passivation solution container and a feature of the passivation solution.

12. The method of claim 6, further comprising:
determining, based on the correlation model and the Raman feature peak intensity, a concentration variation of the passivation solution;
determining a passivation effect based on the concentration variation of the passivation solution;
obtaining a detection feature of the out-field stainless steel substrate, the detection feature being obtained by a detection instrument after the out-field stainless steel substrate completes passivation; and
determining, based on the detection feature and the passivation effect, a corrosion resistance of the out-field stainless steel substrate.

13. The method of claim 6, further comprising:
obtaining a passivation solution temperature collected by a second temperature sensor, a stainless steel temperature collected by a third temperature sensor, and environmental data collected by an environmental detector;
determining an anomaly probability, an electrochemical parameter, a target spectral parameter, and a flow rate of the passivation solution through a parameter model based on the passivation solution temperature, the stainless steel temperature, the environmental data, a temperature range of the passivation solution, and a temperature range of the out-field stainless steel substrate, the anomaly probability including a passivation solution anomaly probability and a stainless steel anomaly probability;
controlling the electrochemical workstation to apply a dynamic potential to the out-field stainless steel substrate based on the electrochemical parameter;
controlling the Raman laser emission source to emit laser to the passivation solution based on the target spectral parameter; and
controlling flow of the passivation solution based on the flow rate of the passivation solution.

14. The method of claim 13, further comprising:
obtaining vibration data of the out-field detection device collected by a vibration sensor, wherein the input of the parameter model includes the vibration data of the out-field detection device, and the anomaly probability further includes a vibration anomaly probability;
determining a device anomaly probability based on the passivation solution anomaly probability, the stainless steel anomaly probability, and the vibration anomaly probability; and
in response to the vibration anomaly probability being greater than a first preset threshold or the device anomaly probability being greater than a second preset threshold, stopping operation of the electrochemical workstation and a peristaltic pump, and sending a warning.

15. The method of claim 14, wherein the first preset threshold is positively correlated with a vibration intensity of an environment where the out-field stainless steel substrate is located.
